(19) United States
(12) Patent Application Publication
(10) Pub. No.: US 2013/0213943 A1
(43) Pub. Date: Aug. 22, 2013

(54) LASER MACHINING METHOD

(71) Applicant: Hiroko Takada, Chiyoda-ku (JP)

(72) Inventor: Hiroko Takada, Chiyoda-ku (JP)

(73) Assignee: MITSUBISHI ELECTRIC CORPORATION, Chiyoda-ku, Tokyo (JP)

(21) Appl. No.: 13/700,816

(22) PCT Filed: Feb. 17, 2012
(86) PCT No.: PCT/JP2012/053876

§ 371 Date: Nov. 29, 2012

(51) Int. Cl. B23K 26/38

(52) U.S. Cl. CPC B23K 26/38
USPC 219/121.69

(57) ABSTRACT

A laser machining method includes a trial machining step of placing a machined material serving as a target of laser machining on a machining table and performing trial machining of the machined material before performing actual machining for cutting out a product from the machined material, wherein the trial machining step includes a cutting-out step of cutting out a trial-machining cut piece having a preset shape from a trial machining area that is set in the machined material by laser machining, a detecting step of detecting whether the trial-machining cut piece remains in the machined material by using the machined material having undergone the cutting-out step as a target to confirm whether the trial-machining cut piece is present, and a determining step of determining whether shifting to the actual machining is permitted according to a detection result at the detecting step.

### FIELD

The present invention relates to a laser machining method.

### BACKGROUND

Conventionally, in laser machining, when a meltage is generated on a machined surface or when a meltage lifts from a machined surface, there is a procedure to determine that a processing defect has occurred and to stop the machining. For example, in laser machining in which a product is cut out from a plate material and dropped, a state where the product does not fall from a plate material may occur, because of a meltage adhered on to a back surface of the plate material or because machining of the plate material is not performed sufficiently to its back surface. In this case, occasionally, such a state is not regarded as a processing defect and consequently machining is continued with the product remained without falling from the plate material. For example, in continuous machining by an automatic operation, the above problem becomes the cause of generating many defective products.

To solve this problem, there has been proposed a technique to detect the fall-out of a workpiece below a work shooter by a vibration sensor that serves as a fall-out detecting unit and to stop the operation of a laser machining device when the fall-out of a product is not detected (see, for example, Patent Literature 1).

### CITATION LIST

### Patent Literature

Patent Literature 1: Japanese Patent Application Laid-open No. 2001-179691

### SUMMARY

### Technical Problem

In a configuration to detect the fall-out of a workpiece below the work shooter, even though the workpiece has correctly fallen out of a machined material, the workpiece may remain between a machining table and the fall-out detecting unit for some causes. Therefore, there is a case in which whether the workpiece has correctly fallen out of the machined material is erroneously verified.

The present invention has been achieved to solve the above problems, and an object of the present invention is to provide a laser machining method in which, in laser machining for cutting out a product from a machined material, whether a workpiece has correctly fallen out of a machined material can be appropriately determined and efficient machining can be performed.

### Solution to Problem

A laser machining method according to one aspect of the present invention includes a trial machining step of placing a machined material serving as a target of laser machining on a machining table and performing trial machining on the machined material before performing actual machining for cutting out a product from the machined material. The trial machining step includes a cutting-out step of cutting out a trial-machining cut piece having a preset shape from a trial machining area that is set in the machined material by the laser machining, a detecting step of detecting whether the trial-machining cut piece remains in the machined material by using the machined material having undergone the cutting-out step as a target to verify whether the trial-machining cut piece is present, and a determining step of determining whether shifting to the actual machining is permitted according to a detection result at the detecting step.

### Advantageous Effects of Invention

The laser machining method according to the present invention uses a machined material as a target to directly verify whether a trial-machining cut piece that is a workpiece at a trial machining step remains in the machined material, and thus can appropriately determine whether the trial-machining cut piece has correctly fallen out of the machined material. The laser machining method shifts to actual machining after verifying that the trial-machining cut piece has correctly fallen out, and thus the method is capable of preventing continuation of machining with a product remained without falling out of the plate material and also preventing a stoppage of shifting to the actual machining despite the fact that the machining capable of correctly dropping the product can be performed. With this configuration, in laser machining for cutting a product from a machined material, whether a workpiece has correctly fallen out of the machined material can be appropriately determined and efficient machining can be performed.

### BRIEF DESCRIPTION OF DRAWINGS

FIG. 1 depicts a configuration of a laser machining device that applies a laser machining method according to an embodiment of the present invention.

FIG. 2 is a top view of a machined material placed on a machining table.

FIG. 3 is a top view of an example of a trial-machining cut piece cut out from a machined material.

FIG. 4 is a schematic diagram of a state where a gap to a material substrate from which a trial-machining cut piece has correctly fallen is measured.

FIG. 5 is a flowchart for explaining a procedure of the laser machining method according to the embodiment.

### DESCRIPTION OF EMBODIMENTS

Exemplary embodiments of a laser machining method according to the present invention will be explained below in detail with reference to the accompanying drawings. The present invention is not limited to the embodiments.

### Embodiment

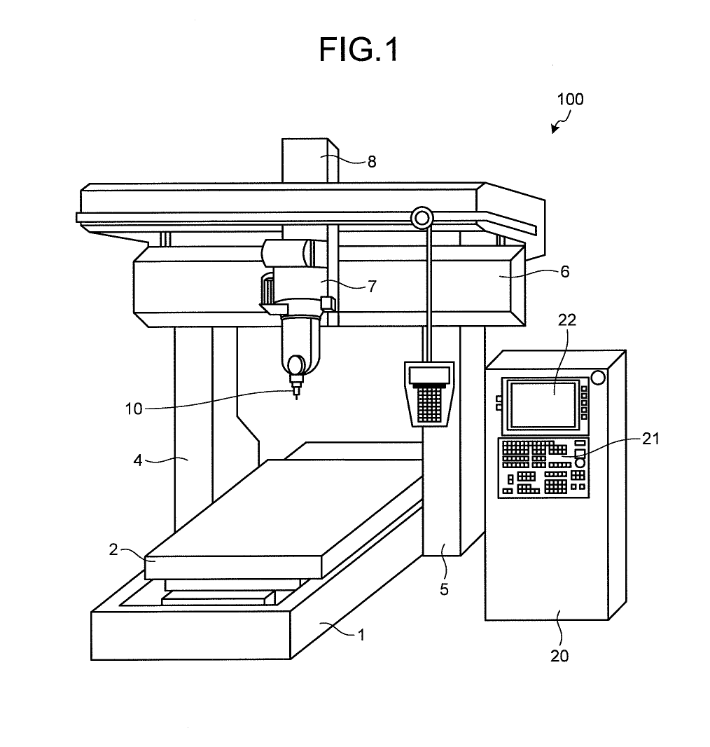

FIG. 1 depicts a configuration of a laser machining device that applies a laser machining method according to an embodiment of the present invention. A laser machining device 100 includes a machining table 2, left and right columns 4 and 5, a cross rail 6, a Y-axis unit 7, a Z-axis unit 8, a machining head 10, and a machining control device 20.

The machining table 2 is movably provided on a bed 1. A material to be machined (hereinafter referred to just as “machined material”) serving as a target of laser machining is placed on the machining table 2. The cross rail 6 bridges horizontally between the columns 4 and 5. The Y-axis unit 7 is movably provided in a Y-axis direction on the cross rail 6. The Z-axis unit 8 is movably provided in a Z-axis direction on the Y-axis unit 7. The machining head 10 is mounted on the Z-axis unit 8. A machining nozzle (a laser nozzle) is mounted on a distal end of the machining head 10.

The machining control device 20 is a man-machine interface and includes an operation panel 21 and a screen display unit 22. The screen display unit 22 is a liquid crystal panel, for example. The machining control device 20 controls positions of the machining table 2, the Y-axis unit 7, and the Z-axis unit 8 by providing respective axis commands to an X-axis servo motor, a Y-axis servo motor, and a Z-axis servo motor (all not shown).

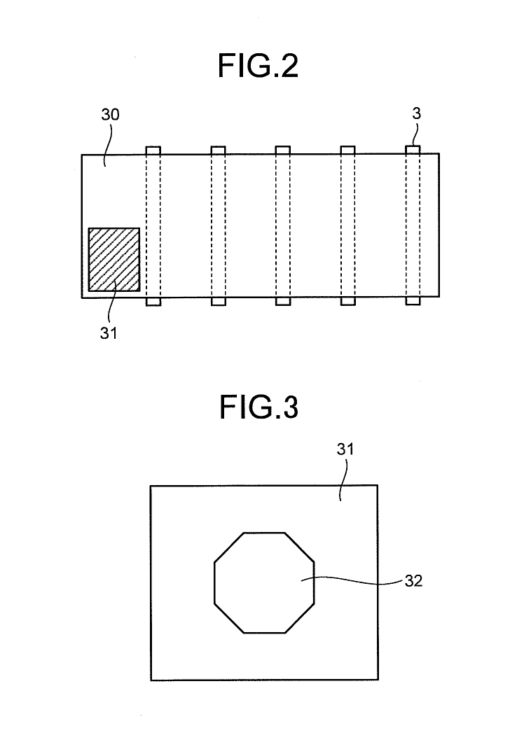

FIG. 2 is a top view of a machined material placed on a machining table. A machined material 30 is a plate made of a metal material, for example. A plurality of work supports 3 support the machined material 30 on the machining table 2. The machined material 30 is supported horizontally by the work supports 3 spaced apart from each other.

The laser machining device 100 drops a product cut from the machined material 30 by laser machining onto the machining table 2.

In the laser machining method according to the present embodiment, the machined material 30 is placed on the work supports 3 of the machining table 2 to perform trial machining of the machined material 30 before performing actual machining for cutting out a product from the machined material 30.

The laser machining device 100 performs the trial machining to a predetermined trial machining area 31 in the machined material 30. The trial machining area 31 is positioned at one of corners of a rectangular shape formed by the machined material 30 on the front-end side toward the machining table 2 to which the machined material 30 is carried in.

A procedure of the laser machining method according to the present embodiment is next explained with reference to FIGS. 3 to 5. FIG. 5 is a flowchart for explaining a procedure of the laser machining method according to the present embodiment. In Step S1, the machined material 30 is carried in to the machining table 2.

When the machined material 30 is carried in to the machining table 2, the laser machining device 100 starts machining (Step S2). The laser machining device 100 reads an NC program for laser machining and starts machining according to an operation of the operation panel 21 conducted by an operator, for example. The laser machining device 100 performs Steps S1 and S2 through an operation by an operator, for example. The laser machining device 100 can also carry in and carry out the machined material 30 by an automatic operation using a pallet changer.

The laser machining device 100 moves the machining head 10 to a preset trial machining area 31 (Step S3) to start a trial machining step. The laser machining device 100 performs laser machining for cutting out a trial-machining cut piece from the trial machining area 31 (Step S4). Step S4 is a cutting-out step included in the trial machining step.

FIG. 3 is a top view of an example of a trial-machining cut piece cut out from a machined material. A trial-machining cut piece 32 has a regular octagonal shape, for example. The laser machining device 100 performs laser machining for cutting the trial machining area 31 along a preset regular octagonal shape. The trial-machining cut piece 32 has a width of 50 millimeters regardless of the thickness of the machined material 30, for example. The width of the trial-machining cut piece 32 can be changed depending on the thickness of the machined material 30, for example. The trial-machining cut piece 32 can have a shape of an actual product.

When the laser machining device 100 finishes the laser machining for cutting out the trial-machining cut piece 32, the laser machining device 100 moves the machining head 10 to the central position of a part where the trial-machining cut piece 32 is cut out (Step S5). By a profile control using the machining head 10, the laser machining device 100 measures a gap between the machining head 10 and the central position of a part of the machined material 30 where the trial-machining cut piece 32 is cut out.

The laser machining device 100 measures a gap between the machining head 10 and the machined material 30 as a voltage. The laser machining device 100 compares the measured voltage and a preset reference value (Step S6). The laser machining device 100 verifies whether the trial-machining cut piece 32 is present immediately below the machining head 10 based on a result of the comparison between the measured voltage and the reference value.

The laser machining device 100 uses the machined material 30 having undergone the cutting-out step as a target to verify whether the trial-machining cut piece 32 is present, thereby detecting whether the trial-machining cut piece 32 remains in the machined material 30.

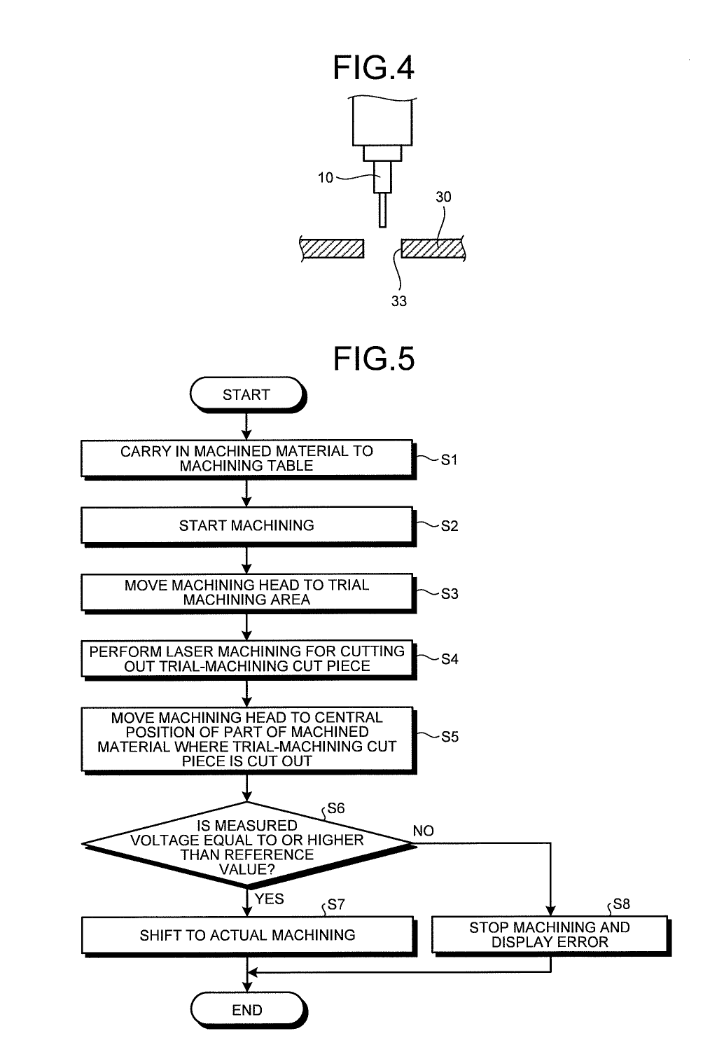

FIG. 4 is a schematic diagram of a state where a gap to a material substrate from which a trial-machining cut piece has correctly fallen out is measured. In FIG. 4, the machined material 30 is shown as a cross-sectional configuration. An opening 33 that is a space created after the fall-out of the trial-machining cut piece 32 is formed in the machined material 30. The laser machining device 100 moves the machining head 10 above the central position of the opening 33 to measure the gap.

When the trial-machining cut piece 32 has correctly fallen out and does not remain in the machined material 30, the measured voltage is equal to or higher than the reference value. When the measured voltage is equal to or higher than the reference value (YES at Step S6), the laser machining device 100 shifts to the actual machining (Step S7) and continues machining. By the actual machining, the laser machining device 100 performs machining for cutting out a product with respect to the machined material 30 in its entirety.

When the trial-machining cut piece 32 has not fallen out of the machined material 30 and remains therein for reasons such as adherence of a meltage to a back surface of the machined material 30 and insufficient cutting, the measured voltage is made lower than the reference value. When the measured voltage is lower than the reference value (NO at Step S6), the laser machining device 100 does not shift to the actual machining and stops machining (Step S8). In addition, the laser machining device 100 performs error display on the screen display unit 22, for example.

The laser machining device 100 determines whether shifting to actual machining is permitted according to a detection result at a detecting step. Step S6 is a detecting step and a determining step that are included in the trial machining step. The laser machining device 100 then finishes machining to the machined material 30.

When an abnormality in which the trial-machining cut piece 32 remains in the machined material 30 is detected at the trial machining step, the laser machining device 100 stops machining, thereby preventing a processing defect in advance. In a case of continuously machining a plurality of the machined materials 30 by an automatic operation, the laser machining device 100 can effectively prevent a situation where many defective products are generated. For example, when the cause of the defect is contamination of a lens through which a laser beam passes or a crushed nozzle, which is difficult for the laser machining device 100 to recover from the defect without receiving any maintenance and is difficult to solve the defect by an automatic control, a procedure of stopping machining such as Step S8 is effective.

The laser machining device 100 uses the machined material 30 as a target to directly verify whether the trial-machining cut piece 32 remains in the machined material 30, and is therefore capable of accurately determining whether the trial-machining cut piece 32 has correctly fallen out of the machined material 30. The laser machining device 100 is capable of preventing continuation of machining when a product does not fall out, and preventing stopping of shifting to the actual machining in a state in which a product can correctly fall out during the machining. With this configuration, in laser machining for cutting a product from the machined material 30, the laser machining device 100 is capable of appropriately determining whether a workpiece has correctly fallen out of the machined material 30, and can perform efficient machining.

By having the trial-machining cut piece 32 as an octagonal shape, the laser machining device 100 can verify whether laser machining is performed correctly in eight directions in the two-dimensional direction. The trial-machining cut piece 32 can also have a shape other than the regular octagonal shape described in the present embodiment. For example, the trial-machining cut piece 32 can have a circular shape.

By utilizing a profile control using the machining head 10 also in the trial machining step, the laser machining method according to the present embodiment can eliminate the need to add any complicated configuration and perform trial machining easily. The laser machining device 100 is not limited to a case in which whether the trial-machining cut piece 32 remains in the machined material 30 is detected by measuring a gap by using the machining head 10.

The laser machining device 100 can apply any means for verifying whether the trial-machining cut piece 32 is present by using the machined material 30 as a target. For example, the laser machining device 100 can apply detection by an infrared sensor, imaging by a camera, or detection by contacting using a contact or the like to check whether the trial-machining cut piece 32 is present.

The laser machining device 100 performs trial machining every time the machined material 30 is carried in to the machining table 2, for example. Apart from performing trial machining to all the machined materials 30 carried in to the machining table 2, it is also possible that the laser machining device 100 performs trial machining only to a part of the machined materials 30 carried in to the machining table 2. For example, the laser machining device 100 can perform trial machining to the machined materials 30 at intervals of a predetermined number among the machined materials 30 carried in to the machining table 2. By omitting the trial machining to a part of the machined materials 30, and the laser machining device 100 can achieve efficiency in product machining.

It is also possible to configure that, for example, the laser machining device 100 performs trial machining to the machined materials 30 at a predetermined time interval. It is also possible to configure that the laser machining device 100 calculates an integration of time during which machining is continued to perform the trial machining at a predetermined integrated-time interval. It is also possible to configure that the laser machining device 100 calculates an integration of the laser output in machining to perform trial machining at an interval of a predetermined integrated laser output. By performing trial machining according to a lapse of time or an elapsed time during which machining is continued, the laser machining device 100 can effectively deal with a processing defect caused by changes in operating conditions and the like over time.

### REFERENCE SIGNS LIST

1 bed

2 machining table

3 work support

4, 5 column

6 cross rail

7 Y-axis unit

8 Z-axis unit

10 machining head

20 machining control device

21 operation panel

22 screen display unit

30 machined material

31 trial machining area

32 trial-machining cut piece

33 opening

100 laser machining device

1. A laser machining method comprising a trial machining step of placing a machined material serving as a target of laser machining on a machining table and performing trial machining on the machined material before performing actual machining for cutting out a product from the machined material, wherein
the trial machining step includes
a cutting-out step of cutting out a trial-machining cut piece having a preset shape from a trial machining area that is set in the machined material by the laser machining,
a detecting step of detecting whether the trial-machining cut piece remains in the machined material by using the machined material having undergone the cutting-out step as a target to verify whether the trial-machining cut piece is present, and
a determining step of determining whether shifting to the actual machining is permitted according to a detection result at the detecting step.

2. The laser machining method according to claim 1, wherein in the detecting step, a gap between a machining head for the laser machining and a part of the machined material where the trial-machining cut piece has been cut out is measured to verify whether the trial-machining cut piece is present based on a measurement result of the gap.

3. The laser machining method according to claim 1, wherein the trial-machining cut piece has an octagonal shape.
